(19) United States
(12) Patent Application Publication
(10) Pub. No.: US 2005/0040611 A1
(43) Pub. Date: Feb. 24, 2005

(54) Vehicle load monitoring and feedback system

(76) Inventors: Scott L. Williston, Rochester Hills, MI (US); Alan H. MacDonald, Novi, MI (US); James J. Kowalik, Commerce Twp., MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/646,649

(22) Filed: Aug. 21, 2003

(51) Int. Cl. B60G 17/00

(52) U.S. Cl. 280/6.159; 177/137

(57) ABSTRACT

A payload monitoring system for a vehicle includes a first spring device and a first pressure transducer. The first pressure transducer generates a first pressure signal based on a pressure of the first spring device. A controller determines a payload of the vehicle based on the first pressure signal. The controller indicates the payload to an operator. The controller signals a warning if the payload is greater than a payload threshold.

### FIELD OF THE INVENTION

The present invention relates to vehicles and more particularly to a vehicle payload monitoring system.

### BACKGROUND OF THE INVENTION

The maximum weight or payload a vehicle can carry is a function of the particular design of the vehicle. For example, a passenger car is designed to carry less payload than a truck or SUV. The payload that the vehicle carries influences handling, braking, and tire wear.

Vehicle loading raises the center of gravity of the vehicle. The additional payload also results in a longer stopping distance during braking. Also, added payload may influence tire wear. Each of these factors influence the operation of the vehicle.

Currently, vehicle operators can only estimate the payload that the vehicle is carrying. As a result, an operator may be unaware of vehicle overloading that would adversely impact performance of the vehicle. On the other hand, the operator may also underload the vehicle and fail to use of the vehicle's cargo-carrying capacity efficiently.

### SUMMARY OF THE INVENTION

The present invention provides a payload monitoring system for a vehicle. The payload monitoring system includes a first spring device and a first pressure transducer. The first pressure transducer generates a first pressure signal based on a pressure of the first spring device. A controller determines a payload of the vehicle based on the first pressure signal.

In one feature, a first sensor generates a first position signal and a first compressor adjusts the first spring device based on the first position signal.

In another feature, the payload monitoring system further includes a second spring device and a second pressure transducer. The second pressure transducer generates a second pressure signal based on a pressure of the second spring device. The controller determines a payload of the vehicle based on the first and second pressure signals.

In still another feature, a second sensor generates a second position signal and a compressor adjusts the first and second spring devices based on the second position signal.

In yet another feature, the controller indicates the payload to an operator.

In another feature, the controller signals a warning if the payload is greater than a payload threshold.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of a vehicle including a vehicle payload monitoring system for a single-axle leveling system;

FIG. 2 is a functional block diagram of the vehicle of FIG. 1 including a dual-axle leveling system; and

FIG. 3 is a flowchart illustrating steps for monitoring a vehicle payload according to the present invention.

### DETAILED DESCRIPTION OF THE PREFERRED EMBODIMENTS

The following description of the preferred embodiment is merely exemplary in nature and is in no way intended to limit the invention, its application, or uses. For purposes of clarity, the same reference numbers will be used in the drawings to identify similar elements.

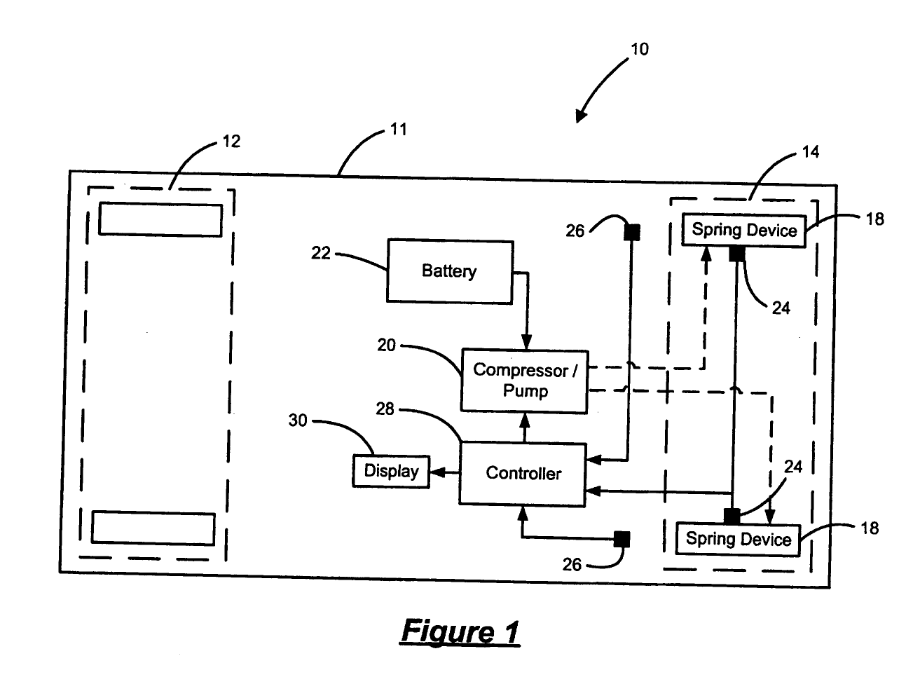

Referring now to FIG. 1, a vehicle 10 is shown including a chassis 11 supported on a front suspension 12 and a rear suspension 14. A pair of spring devices 18 are associated with the rear suspension 14. The spring devices 18 are pneumatically or hydraulically adjusted to level the chassis 11 relative to a reference surface such as the ground. The spring devices include one of an air spring, a hydraulic spring, a hydro-pneumatic device or an air-lift shock absorber.

In the case of pneumatically adjusted spring devices, an air compressor 20 injects or exhausts air into the spring devices 18 through air lines. For hydraulically adjusted spring devices, a hydraulic pump 20 injects or exhausts fluid into the spring devices 18 through the fluid lines. Fluid pressure to the spring devices 18 is increased by the compressor/pump 20 to lengthen the spring devices 18. Fluid pressure is relieved from the spring devices 18 by the compressor/pump 20 to shorten the spring devices 18. Lengthening the spring devices 18 increases the chassis height from the reference surface. Shortening the spring devices 18 decreases the chassis height from the reference surface. The compressor/pump 20 is powered by a battery 22. It is also anticipated, however, that the compressor/pump 20 can be mechanically driven by an engine (not shown).

Pressure sensors 24 generate pressure signals indicative of fluid (gas or liquid) pressure within the respective spring devices 18. The fluid pressure within the spring devices 18 is based on the desired length of the spring devices 18. For example, to increase the length of the spring devices 18, fluid pressure is increased. To decrease the length of the spring devices 18, fluid pressure is decreased.

A position sensor 26 generates a position signal that is sent to a controller 28. It is anticipated that multiple position sensors 26 may be implemented. The position sensor 26 detects whether the chassis 11 is at a target trim position relative to the reference surface. For example, if the chassis 11 is initially level and payload is added, the added payload depresses the chassis 11 on the front and/or rear suspensions 12,14 with respect to the reference surface so that it is no longer level. In this case, the position sensor 26 signal indicates a depressed condition relative to level and the controller 28 directs the compressor/pump 20 to increase fluid pressure to the spring devices 18. Similarly, if the chassis 11 is initially level and payload is removed, the front and rear suspensions 12,14 raise the chassis 11 relative to the reference surface. In this case, the position sensor signal indicates an elevated condition relative to level and the controller 28 directs the compressor/pump 20 to decrease fluid pressure to the adjustable shock absorbers 18.

The spring devices 18 are adjusted to trim the height of the vehicle 10 to the target trim position. The height of the vehicle 10 is maintained within a trim range. Thus, when the vehicle is depressed or elevated as a result of payload change, the spring devices 18 are actuated to adjust the height of the vehicle 10 until it is within the trim range. The trim range is a tolerance about the target trim position.

Once the vehicle 10 is positioned within the trim range, the controller 28 receives the pressure signals and position signals generated by the pressure sensors 24 and position sensor 26, respectively. The controller 28 calculates the payload of the vehicle 10 based on the pressure signals, position signals and pre-programmed vehicle parameters. More particularly, the controller 28 makes an initial calculation based on the pressure signals. The calculation is then refined based on the position signal. In this manner, the calculated payload accounts for the vehicle position within the trim band versus the target trim position. The position signal is a voltage output that is scaled to provide a load value. The load value is then adjusted from the initial payload value based on whether the position of the vehicle 10 is above or below the target trim position. A payload signal is generated by the controller 28 and is sent to an operator display 30. The display 30 visually informs a vehicle operator of the current payload.

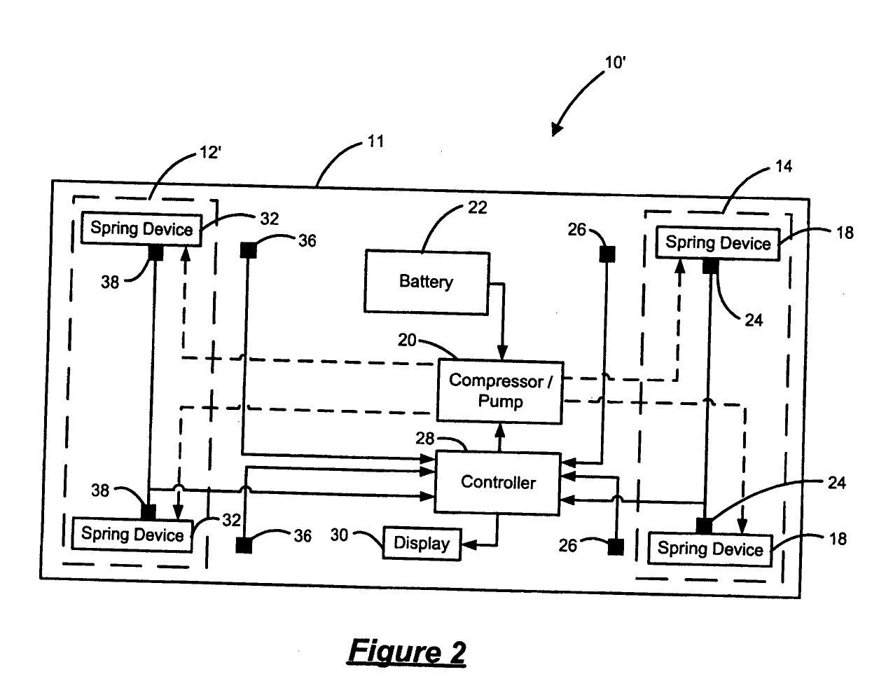

With reference to FIG. 2, a front suspension 12′ of a vehicle 10′ includes adjustable spring devices 32. The compressor/pump 20 regulates the fluid pressure to the spring devices 32 based on a position signal generated by a position sensor 36. Multiple position sensors 36 may be implemented. Pressure signals are generated for the spring devices 32 by pressure sensors 38. The pressure signals are sent to the controller 28. As discussed above, the controller 28 calculates the payload based on the pressure signals from the pressure sensors 24, the pressure sensors 38, the position sensors 26 and the position sensors 36. A payload signal is generated by the controller 28 and is sent to the operator display 30.

The payload information can be provided as a percentage of the payload rating of the vehicle 10, 10′ or as an actual payload (kg or lbs_{f}). The information can also be provided based on the payload distribution within the vehicle 10, 10′. For example, the display 30 can indicate the payload over the front and rear suspensions 12, 14 as an actual payload or a percentage of the total payload calculated. Such a payload distribution can also be displayed for the left and right sides of the vehicle 10, 10′.

A payload threshold is pre-programmed into the controller 28 as a percent of the payload rating or as an actual payload (kg or lbs_{f}). For example, the payload threshold could be pre-programmed as 90% or 95% of the payload rating. It can be appreciated that the specific value of the payload threshold may vary from these exemplary values based on the particular type of vehicle and other design considerations. If the payload is equal to or greater than the payload threshold, a visual or audible signal is generated warning the operator of an overload condition.

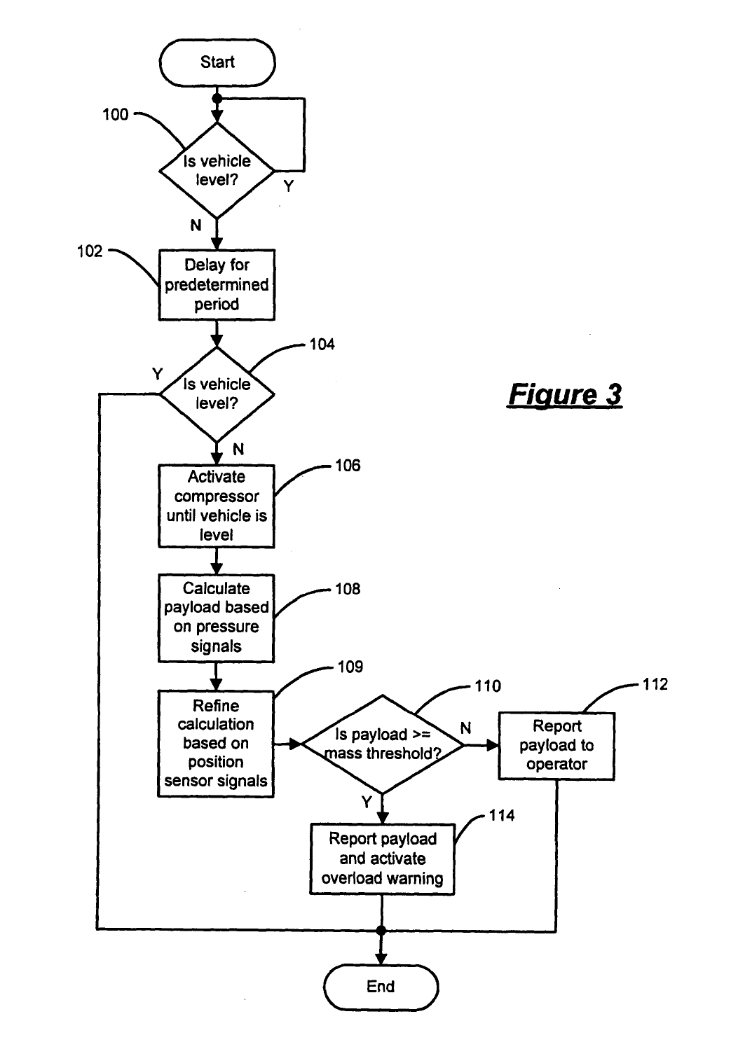

Referring now to FIG. 3, a payload monitoring control will be described in detail. In step 100, control determines whether the chassis 11 is at the targeted trim position as indicated by the position sensors 24,36. If the chassis 11 is at the targeted trim position, control loops back. If the chassis 11 is not at the targeted trim position, control waits a predetermined period in step 102. The predetermined period provides sufficient time for the chassis 11 to settle if jostled or somehow temporarily handled to induce a temporary non-level condition. After the predetermined period expires, control again determines whether the chassis 11 is at the targeted trim position in step 104. If the chassis 11 is at the targeted trim position, control ends. If the chassis 11 is not at the targeted trim position, control continues in step 106.

In step 106, control regulates the compressor/pump 20 until the chassis 11 is at the targeted trim position. In step 108, control calculates the payload based on the pressure signals and position signals and control refines the payload calculation based on the position sensor signals in step 109. In step 110, control determines whether the payload is greater than or equal to the payload threshold. If the payload is not greater than or equal to the payload threshold, control reports the current payload in step 112. If the payload is greater than the threshold, control reports the current payload and activates an overload warning in step 114.

The payload monitoring system of the present invention improves operation of a vehicle. The operation is enhanced as a result of the operator being aware of the payload the vehicle is carrying. By avoiding overloading, the vehicle handling is enhanced, tire wear decreased and stopping distance reduced. Additionally, the operator can make more efficient use of the vehicle's payload carrying capability by avoiding underloading.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. A payload monitoring system for a vehicle, comprising:
a first adjustable spring device;
a first pressure transducer that generates a first pressure signal based on a pressure of said first spring device; and
a controller that determines a payload of said vehicle based on said first pressure signal.

2. The payload monitoring system of claim 1 wherein said first spring device is adjusted pneumatically.

3. The payload monitoring system of claim 2 further comprising:
a first sensor generating a position signal; and
a first compressor that adjusts said first spring device based on said position signal.

4. The payload monitoring system of claim 1 wherein said first adjustable shock absorber is adjusted hydraulically.

5. The payload monitoring system of claim 4 further comprising:
a first sensor generating a position signal; and
a first hydraulic pump that adjusts said first spring device based on said position signal.

6. The payload monitoring system of claim 1 further comprising:
a second spring device; and
a second pressure transducer that generates a second pressure signal based on a pressure of said second spring device, wherein said controller determines a payload of said vehicle based on said first and second pressure signals.

7. The payload monitoring system of claim 6 wherein said first and second spring devices are adjusted pneumatically.

8. The payload monitoring system of claim 7 further comprising:
a second sensor generating a position signal; and
a compressor that adjusts said first and second spring devices based on said position signal.

9. The payload monitoring system of claim 6 wherein said first and second spring devices are adjusted hydraulically.

10. The payload monitoring system of claim 9 further comprising:
a second sensor generating a position signal; and
a hydraulic pump that adjusts said first and second spring devices based on said position signal.

11. The payload monitoring system of claim 1 wherein said controller indicates said payload to an operator.

12. The payload monitoring system of claim 1 wherein said controller signals a warning if said payload is greater than a threshold payload.

13. A method of monitoring a payload of a vehicle, comprising:
detecting a payload change within said vehicle;
adjusting a spring device to compensate for said payload change;
generating a pressure signal based on a pressure of said spring device; and
calculating a payload value based on said pressure signal.

14. The method of claim 13 further comprising informing an operator of said payload value.

15. The method of claim 13 further comprising:
comparing said payload value to a threshold value; and
warning an operator if said payload value is greater than said threshold value.

16. The method of claim 13 wherein said step of detecting a payload change includes detecting a change in vehicle position.

17. The method of claim 13 further comprising:
initiating a delay period if a payload change is detected; and
confirming said payload change upon expiration of said delay period.

18. The method of claim 13 wherein said step of adjusting a spring device includes adjusting hydraulic pressure supplied to said spring device.

19. The method of claim 13 wherein said step of adjusting a spring device includes adjusting pneumatic pressure supplied to said spring device.

20. The method of claim 13 wherein a pressure sensor generates said pressure signal.

21. The method of claim 13 further comprising generating a position signal of said vehicle wherein said step of adjusting a spring device to compensate is based on said position signal.

22. The method of claim 13 further comprising:
generating a position signal of said vehicle; and
refining said payload value based on said position signal.

23. A method of monitoring a payload of a vehicle, comprising:
detecting a payload change within said vehicle;
adjusting a spring device to compensate for said payload change;
generating a pressure signal based a pressure of said spring device;
calculating a payload value based on said pressure signal; informing an operator of said payload value;
comparing said payload value to a threshold; and
warning an operator if said payload value is greater than said threshold value.

24. The method of claim 23 wherein said step of detecting a payload change includes detecting a change in vehicle position.

25. The method of claim 23 further comprising:
initiating a delay period if a payload change is detected; and
confirming said payload change upon expiration of said delay period.

26. The method of claim 23 wherein said step of adjusting a spring device includes adjusting hydraulic pressure supplied to said spring device.

27. The method of claim 23 wherein said step of adjusting a spring device includes adjusting pneumatic pressure supplied to said spring device.

28. The method of claim 23 wherein a pressure sensor generates said pressure signal.

29. The method of claim 23 further comprising generating a position signal of said vehicle wherein said step of adjusting a spring device to compensate is based on said position signal.

30. The method of claim 23 further comprising: generating a position signal of said vehicle; and refining said payload value based on said position signal.
